(19) United States
(12) Patent Application Publication
(10) Pub. No.: US 2010/0301830 A1
(43) Pub. Date: Dec. 2, 2010

(54) SEMICONDUCTOR DEVICE INCLUDING VOLTAGE GENERATOR

(76) Inventor: In Soo WANG, Chungcheongbuk-do (KR)

Correspondence Address: IP & T GROUP LLP, 7700 Little River Turnpike, Suite 207, Annandale, VA, 22003, US

(21) Appl. No.: 12/650,662

(22) Filed: Dec. 31, 2009

(30) Foreign Application Priority Data
May 29, 2009 (KR) 10-2009-0047828

(51) Int. Cl. G05F 3/08

(52) U.S. Cl. 323/311

(57) ABSTRACT

A semiconductor device includes a voltage generator. The voltage generator includes a detection circuit having a number of voltage detection units, each detection unit including a different number of resistors compared to other detection units and each detection unit outputting a respective voltage, a voltage comparison circuit configured to compare a constant voltage to each respective divided voltage outputted from detection units of the detection circuit and to output a number of control signals in response to the comparison, and a reference voltage generator configured to generate a reference voltage in response to the control signals.

### CROSS-REFERENCE TO RELATED APPLICATIONS

Priority to Korean patent application number 10-2009-0047828 filed on May 29, 2009, the entire disclosure of which is incorporated by reference herein, is claimed.

### BACKGROUND

Embodiments of the present invention relate to a semiconductor device and, more particularly, to a semiconductor device including a voltage generator to prevent the deterioration of electrical characteristics.

A semiconductor device is supplied with an external voltage and is configured to raise the level of the external voltage using an internal circuit and to generate a high voltage used as an internal voltage of the semiconductor device. For example, when the external voltage is supplied to the semiconductor device, the internal circuit generates a reference voltage using the external voltage. A clock signal is generated based on the reference voltage. A pump unit raises the level of the external voltage in response to the clock signal to generate the high voltage. The high voltage is used during a program operation, an erase operation and a read operation performed by the semiconductor device. In particular, the program operation is performed using the high voltage as a program voltage. The threshold voltage of a memory cell may be significantly influenced by the program voltage. For example, the threshold voltage can vary according to a change in the voltage level of the program voltage or the time period during which the program voltage is supplied.

FIGS. 1 and 2 are diagrams illustrating known concerns of conventional semiconductor devices.

FIG. 1 is a circuit diagram showing a part of a memory cell array included in a conventional semiconductor device. The memory cell array includes groups of memory cells coupled to different cell strings. The memory cells coupled to different cell strings are electrically coupled through word lines WLn−1 to WLn+1. When a program operation is performed, a program voltage is supplied to the memory cells through the respective word lines WLn−1 to WLn+1. If the time that the supplied program voltage takes to reach the memory cells is not constant, the program operation may not be fully performed on a selected memory cell Sel.Cell. For example, if the resistance value of resistors included within the semiconductor device is higher than a desired value, the time period taken to generate a high voltage can be relatively long. Accordingly, in the case in which a pass voltage Vpass is supplied to the selected memory cell Sel.Cell through the word line WLn, the time period taken to supply the pass voltage Vpass can be relatively long. Furthermore, in the case in which a program voltage Vpgm is supplied to the selected memory cell Sel.Cell through the word line WLn, the time period taken to supply the program voltage Vpgm to the selected memory cell Sel.Cell can be relatively long.

Referring to FIG. 2, if the program pass voltage (Vpass of FIG. 1) or the program voltage (Vpgm of FIG. 1) is not timely supplied to the selected memory cell (Sel. Cell of FIG. 1), the threshold voltage of the selected memory cell can be changed. For example, a distribution of the threshold voltages of memory cells can widen.

As described above, a shift in the level of the high voltage used within the semiconductor device deteriorates the reliability of the semiconductor device. Various factors may change the level of the high voltage. An example of one such factor in which the level of the high voltage is changed according to the resistance value of a resistor included within a semiconductor device is described below.

In fabricating semiconductor devices, it is difficult to accurately meet conditions for manufacturing processes performed on different wafers. Resistors and memory cells may be formed using different processes. In such cases, the manufacturing cost and time may increase.

To address such a concern, the resistors may be formed at the same time that the memory cells are formed. However, if there is a difference in the process conditions for resistors formed in different wafers, the resistance values of the resistors formed in the different wafers may also differ. Furthermore, a semiconductor device includes a number of resistors. If the resistance values of the resistors differ, the duty cycles of clock signals can differ, and accordingly, the time period taken to generate a high voltage can differ. Consequently, since the electrical characteristics of the semiconductor device are deteriorated due to a difference in the resistances, the reliability of the semiconductor device is lowered.

### BRIEF SUMMARY

According to exemplary embodiments of the present invention, a number of resistors are used to divide a voltage, and a reference voltage is generated based on the divided voltage. Accordingly, the time period taken to generate a high voltage can be controlled, and accordingly, the time period taken to perform a program operation remains constant.

A semiconductor device according to an exemplary embodiment of the present invention includes a voltage generator. The voltage generator includes a detection circuit including a different number of resistors compared to other voltage detection units, each voltage detection unit outputting a respective voltage, a voltage comparison circuit configured to compare a constant voltage to each respective voltage outputted from the detection circuit, and to output a number of control signals in response to the comparison, and a reference voltage generator configured to generate a reference voltage in response to the control signals.

A semiconductor device according to another exemplary embodiment of the present invention includes a voltage generator. The voltage generator includes a detection circuit having a number of voltage detection units, each detection unit including a different number of resistors compared to other detection units and each detection unit outputting a respective voltage, a voltage comparison circuit configured to compare a constant voltage to each of respective voltages outputted by the detection units of the detection circuit, and to output a number of control signals in response to the comparison, a reference voltage generator configured to generate a reference voltage in response to the control signals; a clock signal generator configured to generate a clock signal in response to the reference voltage; and a pump unit configured to generate a high voltage in response to the clock signal.

### BRIEF DESCRIPTION OF THE DRAWINGS

FIG. 1 is a circuit diagram showing a part of a memory cell array included in a conventional semiconductor device;

FIG. 2 is a diagram illustrating the relationship between voltage and time in a conventional semiconductor device;

FIG. 3 is a schematic block diagram of a semiconductor device including a voltage generator according to an exemplary embodiment of the present invention;

FIG. 4 shows a block diagram of the voltage generator shown in FIG. 3;

FIG. 5 is a circuit diagram of a voltage detector shown in FIG. 4;

FIG. 6 is a circuit diagram of a reference voltage generator shown in FIG. 4;

FIG. 7 is a circuit diagram of a clock signal generator shown in FIG. 4;

FIG. 8 is a waveform diagram illustrating clock signals according to an exemplary embodiment of the present invention; and

FIG. 9 is a waveform diagram illustrating effects according to an exemplary embodiment of the present invention.

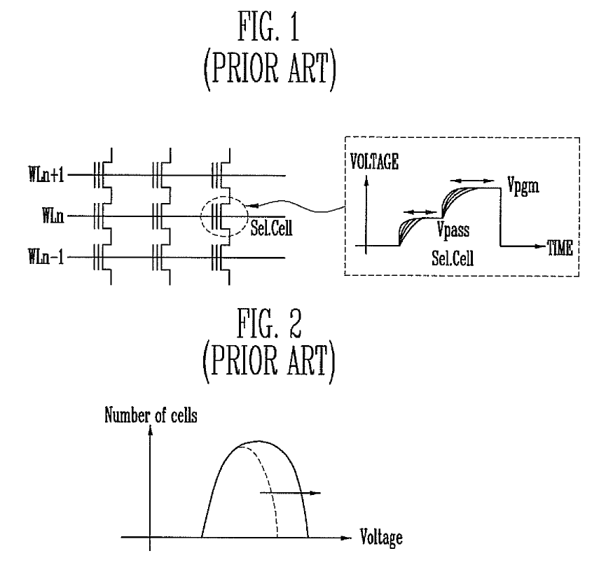

### DESCRIPTION OF EXEMPLARY EMBODIMENTS

Hereinafter, exemplary embodiments of the present invention are described in detail with reference to the accompanying drawings. The drawing figures have been provided to allow those having ordinary skill in the art to understand the scope of the embodiments of the present invention.

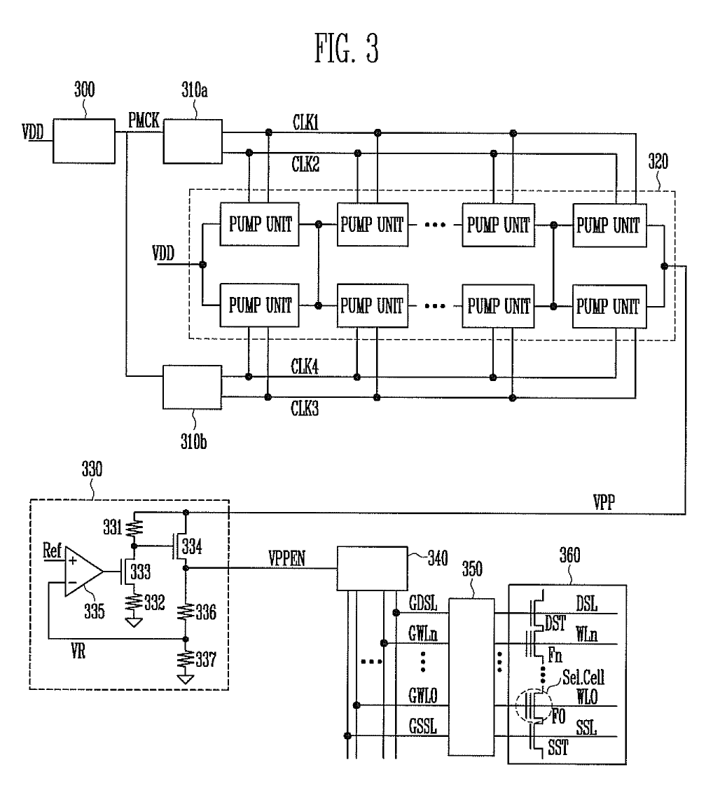

FIG. 3 is a schematic block diagram of a semiconductor device including a voltage generator according to an exemplary embodiment of the present invention.

The semiconductor device includes a voltage generator 300, branch units 310a and 310b, a pump unit 320, a high voltage switch unit 330, an operating voltage generation unit 340, a voltage transfer unit 350, and a memory cell array 360.

The voltage generator 300 is supplied with a power supply voltage VDD and is configured to generate a corrected clock signal PMCK.

The branch units 310a and 310b include a first branch unit 310a configured to generate first and second pump signals CLK1 and CLK2 using the clock signal PMCK and a second branch unit 310b configured to generate third and fourth pump signals CLK3 and CLK4 using the clock signal PMCK.

The pump unit 320 includes a number of pump units. The pump unit 320 is configured to raise the voltage level of the power supply voltage VDD in response to the first to fourth pump signals CLK1 to CLK4 and to generate a high voltage VPP.

The high voltage switch unit 330 is configured to generate a high voltage enable signal VPPEN in response to the high voltage VPP. In more detail, the high voltage switch unit 330 includes a first division resistor 331, a first element 333, and a second division resistor 332 which are coupled in series to a line through which the high voltage VPP is supplied and a terminal for supplying a ground voltage Vss. The high voltage switch unit 330 further includes a second element 334, a third division resistor 336, and a fourth division resistor 337 coupled in series to the line for the high voltage VPP and the terminal for supplying the ground voltage Vss. The high voltage switch unit 330 further includes a comparator 335 configured to compare the voltage level of a division reference voltage Ref to a division transfer voltage VR and to supply an output signal to the gate of the first element 333. The second element 334 is operated in response to voltage supplied to a node of the first division resistor 331 and the first element 333. Furthermore, the division transfer voltage VR supplied to the comparator 335 becomes voltage supplied between the third and fourth division resistors 336 and 337.

The operating voltage generation unit 340 is configured to generate the operation voltages to a global drain selection line GDSL, global word lines GWL0 to GWLn, and a global source selection line GSSL in response to the high voltage enable signal VPPEN. The voltage transfer unit 350 is configured to transfer the operation voltages, generated by the operating voltage generation unit 340, to the drain selection line DSL, the word lines WL0 to WLn, and the source selection line SSL of a selected memory cell block (e.g., the memory cell array 360). The memory cell array 360 includes the drain select transistor DST, memory cells F0 to Fn, and the source select transistor SST which are coupled together in series. The drain select transistor DST, the memory cells F0 to Fn, and the source select transistor SST are operated in response to the driving voltage transferred by the voltage transfer unit 350. The voltage generator 300 is described in more detail below.

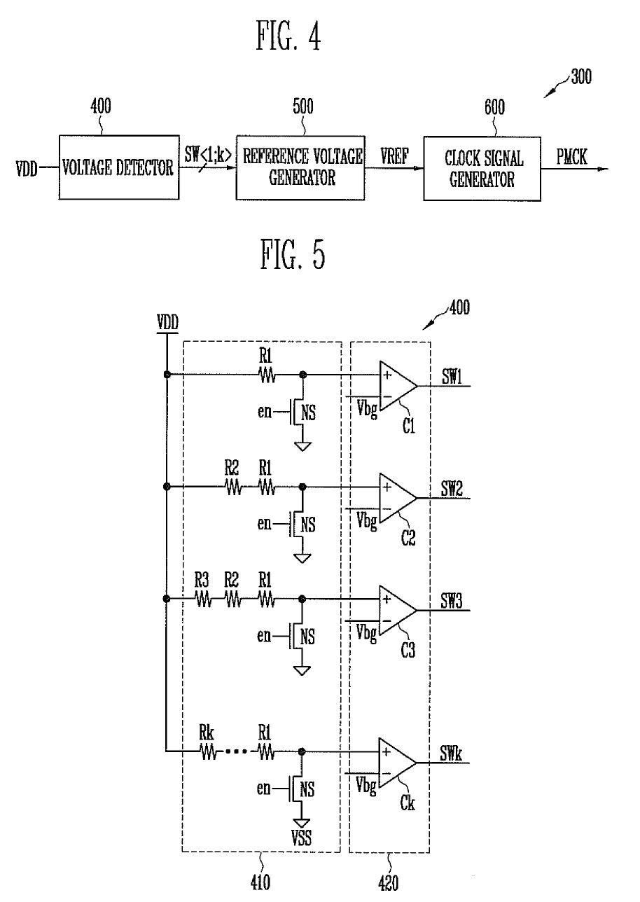

FIG. 4 is a block diagram of the voltage generator 300 shown in FIG. 3.

The voltage generator 300 includes a voltage detector 400, a reference voltage generator 500, and a clock signal generator 600.

The voltage detector 400 is configured to generate control signals SW1 to SWk, divided by resistors, in response to the power supply voltage VDD. The reference voltage generator 500 is configured to generate the reference voltage Vref in response to the control signals SW1 to SWk. The clock signal generator 600 is configured to generate the clock signal PMCK in response to the reference voltage Vref. The voltage detector 400 is described in more detail below.

FIG. 5 is a circuit diagram of the voltage detector 400 shown in FIG. 4.

The voltage detector 400 includes a detection circuit 410 and a voltage comparison circuit 420.

The detection circuit 410 includes a number of voltage detection units. The input terminals of the voltage detection units are in common coupled to a node to which the power supply voltage VDD is supplied, and the output terminals thereof are coupled to different nodes. The voltage detection units include resistors R1 to Rk and enable switches NS. The resistors are coupled together in series in different voltage detection units. The resistors R1 to Rk are coupled to the input terminals of the voltage detection units, and the enable switches NS are coupled to the output terminals of the voltage detection units. Each of the enable switches NS is coupled between an output terminal of a respective voltage detection unit and a ground voltage terminal VSS and each enable switch NS is operated in response to a respective enable signal ‘en’. The resistors R1 to Rk coupled to the voltage detection units are described in more detail below.

Each of the voltage detection units includes a different number of the resistors R1 to Rk. For example, the resistor R1 is coupled to a first voltage detection unit, and two resistors R1 and R2 are coupled to a second voltage detection unit. As described above, k resistors R1 to Rk are coupled to a k^{th} voltage detection unit. If the number of resistors R1 to Rk coupled to the voltage detection units differs for each voltage detection unit as described above, the amount of current supplied to a node coupled to the drain terminal of the respective enable switch NS also differs. However, an enable switch NS is turned off, the voltage level of a node to which the drain terminal of the enable switch NS is coupled is the same regardless of which one of the voltage detection units that the enable switch is a part of. However, when the enable switch NS is turned on, the level of a divided voltage supplied to a node to which the drain terminal of the enable switch NS differs for different ones of the voltage detection units. For example, the level of a divided voltage that is generated is lowered in response to a reduction in the number of resistors in the voltage detection unit.

The voltage comparison circuit 420 includes a number of comparators C1 to Ck. The comparators C1 to Ck are configured to compare the levels of the respective divided voltages, generated by the detection circuit 410, and the level of a bandgap voltage Vbg and to generate the respective control signals SW1 to SWk. In particular, in different wafers, the power supply voltage VDD has the same level as the bandgap voltage Vbg, and the control signals SW1 to SWk with different logic levels are generated in response to the level of the divided voltages generated by the detection circuit 410.

In more detail, when the levels of the divided voltages generated by the respective voltage detection units are higher than the levels of the respective bandgap voltages Vbg, the comparators C1 to Ck generate the respective control signal SW1 to SWk of a logic high level. It is assumed that the power supply voltage VDD and the bandgap voltage Vbg have a constant level. When the levels of the divided voltages generated by the respective voltage detection units are lower than the levels of the bandgap voltage Vbg, the comparators C1 to Ck generate the respective control signal SW1 to SWk of a logic low level. A case in which the third control signal SW3 of a logic high level is outputted from the third comparator C3, and the second control signal SW2 of a logic low level is outputted from the second comparator C2 is described below as an example.

The third control signal SW3 of a logic high level is outputted when the level of the divided voltage supplied to the third comparator C3 is higher than the level of the bandgap voltage Vbg. Thus, the comparators C4 to Ck, which are supplied with the respective divided voltages, each having a voltage level higher than that of the divided voltage supplied to the third comparator C3, output the respective control signals SW4 to SWk of a logic high level. Furthermore, the second control signal SW2 of a logic low level is outputted because the level of the divided voltage supplied to the second comparator C2 is lower than the level of the bandgap voltage Vbg. Thus, the comparator C1, which is supplied with the divided voltage having a voltage level lower than that of the divided voltage supplied to the second comparator C2, outputs the control signal SW1 of a logic low level.

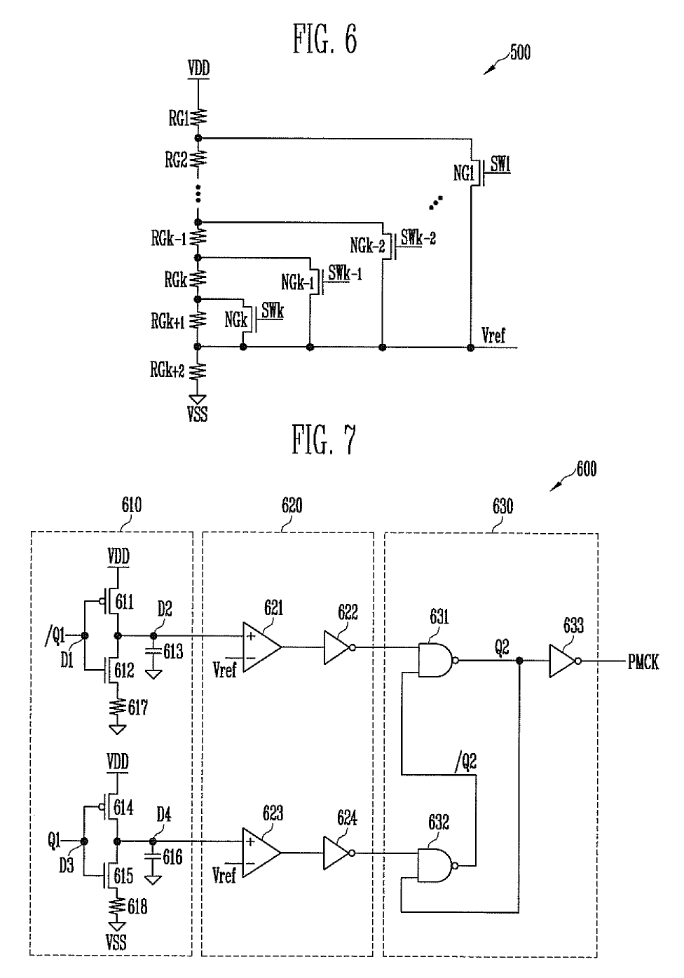

FIG. 6 is a circuit diagram of the reference voltage generator 500 shown in FIG. 4.

The reference voltage generator 500 includes a resistor line in which first to (k+2)^{th} division resistors RG1 to RGk+2 are coupled in series between the terminal for the power source voltage VDD and the terminal for the ground voltage VSS. The reference voltage generator 500 further includes a reference output line Vref coupled to a node between the (k+2)^{th} division resistor RGk+2 and the (k+1)^{th} division resistor RGk+1. The reference voltage generator 500 further includes first to k^{th} switches NG1 to NGk that are coupled between the reference output line and respective nodes between adjacent ones of the first to (k+2)^{th} division resistors RG1 to RGk+2. The first to k^{th} switches NG1 to NGk can be implemented using NMOS transistors.

In more detail, the first switch NG1 has a drain coupled to the node between the first division resistor RG1 and the second division resistor RG2 and a source coupled to the reference output line. The first switch NG1 is operated in response to the first control signal SW1. The k^{th} switch NGk has a drain coupled to the node between the k^{th} division resistor RGk and the (k+1)^{th} division resistor RGk+1 and a source coupled to the reference output line. The k^{th} switch NGk is operated in response to the k^{th} control signal SWk. As described with reference to FIG. 5, in the case in which the (k−2)^{th} switch NGk−2 is turned off and the (k−1)^{th} switch NGk−1 is turned on in response to the first to k^{th} control signals SW1 to SWk outputted from the voltage detector 400, the first to (k−2)^{th} switches NG1 to NGk-2 are turned off, and the (k−1)^{th} to k^{th} switches NGk-1 to NGk are turned on.

In the case in which, as described above, the first to (k−2)^{th} switches NG1 to NGk-2 are turned off and the (k−1)^{th} to k^{th} switches NGk-1 to NGk are turned on, the power supply voltage VDD passes through the first to (k−1)^{th} division resistors RG1 to RGk-1 and then reaches the reference output line Vref via the (k−1)^{th} switch NGk-1. The voltage at the reference output line is the reference voltage Vref. The level of the reference voltage Vref varies according to the operation of the first to k^{th} switches NG1 to NGk. As described above, the voltage detector 400 outputs the control signals SW1 to SWk in response to varying resistance values, and the reference voltage generator 500 generates the reference voltage Vref of a constant level using the control signals SW1 to SWk. Accordingly, a shift in the reference voltage Vref depending on a difference in the resistance, which may occur during the manufacturing process, can be prevented/reduced.

FIG. 7 is a circuit diagram of the clock signal generator 600 shown in FIG. 4.

The clock signal generator 600 includes a clock voltage generator 610, a clock voltage correction unit 620, and a clock output unit 630.

The clock voltage generator 610 includes two inverters to which a first input signal Q1 and an inverted first input signal /Q1 are respectively inputted and second and fourth nodes D2 and D4 from which respective inverted signals are outputted. In more detail, the inverter to which the inverted first input signal /Q1 is inputted includes switch elements 611 and 612 and a resistor 617 coupled in series between the terminal for the power source voltage VDD and the terminal for the ground voltage VSS. The switch element 611 coupled to the terminal for the power source voltage VDD is implemented using a PMOS transistor, and the switch element 612 coupled to the terminal for the ground voltage VSS is implemented using an NMOS transistor. The resistor 617 is coupled between the switch element 612 and the terminal for the ground voltage VSS. The inverted first input signal /Q1 is inputted to a first node D1 coupled to the gates of the switch elements 611 and 612. A capacitor 613 is coupled between the terminal for the ground voltage VSS and the second node D2 between the switch elements 611 and 612. The inverter to which the first input signal Q1 is inputted includes switch elements 614 and 615 and a resistor 618 coupled in series between the terminal for the power source voltage VDD and the terminal for the ground voltage VSS. The switch element 614 coupled to the terminal for the power source voltage VDD is implemented using a PMOS transistor, and the switch element 615 neighboring the terminal for the ground voltage VSS is implemented using an NMOS transistor. The resistor 618 is coupled between the switch element 615 and the terminal for the ground voltage VSS. The first input signal Q1 is inputted to a third node D3 coupled to the gates of the switch elements 614 and 615. A capacitor 616 is coupled between the terminal for the ground voltage VSS and the fourth node D4 between the switch elements 614 and 615.

The clock voltage correction unit 620 includes first and second comparators 621 and 623 and first and second inverters 622 and 624. In more detail, the first comparator 621 is configured to compare the level of voltage supplied to the second node D2 and the level of the reference voltage Vref. If, as a result of the comparison, the level of the reference voltage Vref is determined to be higher than the level of the voltage supplied to the second node D2, the first comparator 621 outputs voltage of a logic low level. If, as a result of the comparison, the level of the reference voltage Vref is determined to be lower than the level of the voltage supplied to the second node D2, the first comparator 621 outputs a voltage of a logic high level. Furthermore, the second comparator 623 is configured to compare the level of voltage supplied to the fourth node D4 and the level of the reference voltage Vref. If, as a result of the comparison, the level of the reference voltage Vref is higher than the level of the voltage supplied to the fourth node D4, the second comparator 623 outputs voltage of a logic low level. If, as a result of the comparison, the level of the reference voltage Vref is lower than the level of the voltage supplied to the fourth node D4, the second comparator 623 outputs voltage of a logic high level. The reference voltage Vref is the reference voltage Vref outputted from the reference voltage generator 500. Despite a difference in the resistance due to the manufacturing process, the reference voltage Vref may maintain a constant voltage level. Accordingly, the first and second comparators 621 and 623 may maintain constant operations in outputting outputs of the comparators despite such resistance differences. The first inverter 622 is configured to invert the voltages outputted from the first comparator 621 and to output an inverted voltage. The second inverter 624 inverts the voltage outputted from the second comparator 623 and outputs the inverted voltage.

The clock output unit 630 includes an inverter 633 and first and second NAND gates 631 and 632. The first NAND gate 631 is configured to generate a second input signal Q2 in response to a signal outputted from the first inverter 622 of the clock voltage correction unit 620, and a signal outputted from the second NAND gate 632. The second NAND gate 632 is configured to generate an inverted second input signal /Q2 in response to the second input signal Q2 and a signal outputted from the second inverter 624 of the clock voltage correction unit 620. The inverter 633 is configured to invert the second input signal Q2 and to output an inverted signal as the clock signal PMCK.

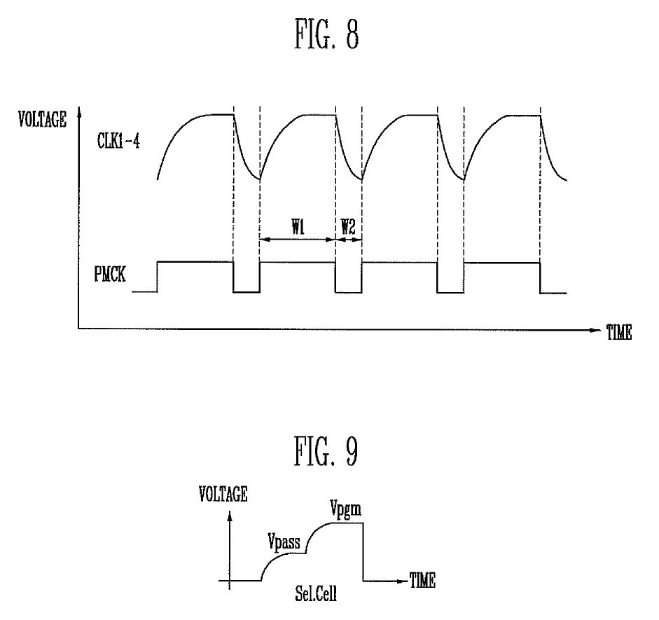

FIG. 8 is a waveform diagram illustrating clock signals according to an exemplary embodiment of the present invention.

Referring to FIGS. 3 and 8, although there exists a resistance difference due to the manufacturing process, the duty cycle of the clock signal PMCK can be adjusted by controlling the level of the reference voltage Vref as described above. Since the duty cycle of the clock signal PMCK can be adjusted, the time period that the high voltage VPP takes to reach a desired level can be controlled. Accordingly, since the time period during which the high voltage enable signal VPPEN is generated by the high voltage switch unit (refer to 330 of FIG. 3) can be controlled, the time period that a program voltage takes to reach the word lines WL0 to WLn can be controlled. For example, in the case in which the resistance value of resistors included in a semiconductor device is higher than a desired value, the time period that a driving voltage takes to reach word lines becomes r can be prevented from being comparatively long by reducing the time period during which the high voltage VPP is generated. In the case in which the resistance value of resistors included in a semiconductor device is lower than a desired value, the time period that a driving voltage takes to reach word lines can be prevented from being comparatively short by increasing the time period during which the high voltage VPP is generated. Since the time period that the driving voltage takes to reach the word lines becomes relatively constant, the reliability of the semiconductor device is improved, and the deterioration of the electrical characteristics of the semiconductor device is prevented.

FIG. 9 is a waveform diagram illustrating effects according to an exemplary embodiment of the present invention.

Referring to FIGS. 3 and 9, when the duty cycles of the first to fourth pump signals CLK1 to CLK4 are made constant as described above with reference to FIG. 8, the level of the high voltage VPP generated from the pump unit 320 can also become constant. When the level of the high voltage VPP becomes constant, the voltage supplied to the word lines can become constant.

A program operation is described below as an example.

During the program operation, a program pass voltage Vpass is supplied to a selected word line coupled to a selected memory cell Sel.Cell, and a program voltage Vpgm is then supplied to the selected memory cell Sel.Cell. At this time, since the high voltage VPP having a constant level is supplied, the levels of the program pass voltage Vpass and the program voltage Vpgm, supplied through the selected word line, and the time period that it takes to supply the voltages is constantly maintained.

As described above, if there is a resistance difference due to the manufacturing process, the duty cycle of the clock signal PMCK is adjusted by controlling the level of the reference voltage Vref. Accordingly, the time period that a driving voltage takes to reach memory cells through a word line becomes constant by controlling the time period during which the high voltage VPP is generated.

Furthermore, according to an exemplary embodiment of the present invention, a number of the resistors are used to divide a voltage, and the reference voltage is generated in response to divided voltages. Accordingly, a change in the time period during which a program operation is performed because of a resistance difference can be prevented/reduced, Consequently, although semiconductor devices have different resistance values, the reliability of the semiconductor devices is improved because the time period during which a program operation is performed is the same.

What is claimed is:

1. A semiconductor device comprising a voltage generator, the voltage generator including:
a detection circuit having a number of voltage detection units, each detection unit including a different number of resistors compared to other voltage detection units and each voltage detection unit outputting a respective voltage;
a voltage comparison circuit configured to compare a constant voltage to each respective voltage outputted from the detection units of the detection circuit, and to output a number of control signals in response to the comparison; and
a reference voltage generator configured to generate a reference voltage in response to the control signals.

2. The semiconductor device of claim 1, wherein the detection circuit comprises:
a number of resistors within each of the voltage detection units, wherein the number of resistors are coupled in series within the voltage detection unit; and
a number of enable switches coupled to the respective voltage detection units.

3. The semiconductor device of claim 2, wherein each of the voltage detection units has one side coupled to a power supply voltage input terminal and another side coupled to the voltage comparison circuit.

4. The semiconductor device of claim 3, wherein:
the resistors in each of the voltage detection units are coupled to the power supply voltage input terminal, and
the respective enable switch of the voltage detection unit is coupled at a node between the resistors of the voltage detection unit and the voltage comparison circuit.

5. The semiconductor device of claim 2, wherein each of the enable switches comprises an NMOS transistor.

6. The semiconductor device of claim 2, wherein each of the enable switches is coupled between a ground voltage input terminal and an output node of the respective voltage detection unit.

7. The semiconductor device of claim 1, wherein the voltage comparison circuit comprises a number of comparators coupled to respective output nodes of the voltage detection units and configured to output the respective control signals.

8. The semiconductor device of claim 7, wherein each of the comparators is configured to output the control signal of a logic high level in response to a level of the voltage outputted by the detection circuit being higher than the constant voltage and to output the control signal of a logic low level in response to a level of the voltage outputted by the detection circuit being lower than the constant voltage.

9. The semiconductor device of claim 1, wherein the constant voltage includes a bandgap voltage.

10. The semiconductor device of claim 1, wherein the reference voltage generator comprises:
a resistor line including a number of resistors coupled in series between a power supply voltage input terminal and a ground voltage input terminal;
a reference output line coupled to a node between the resistor connected to the ground voltage input terminal and other resistors; and
a number of switches each coupled between the reference output line and a respective node between the resistors.

11. The semiconductor device of claim 10, wherein the switches are operated in response to the respective control signals and configured to output the reference voltage to the reference output line.

12. A semiconductor device comprising a voltage generator, the voltage generator including:
a detection circuit having a number of voltage detection units, each detection unit including a different number of resistors compared to other detection units and each detection unit outputting a respective voltage;
a voltage comparison circuit configured to compare a constant voltage to each respective voltage outputted by the detection units of the detection circuit, and to output a number of control signals in response to the comparison;
a reference voltage generator configured to generate a reference voltage in response to the control signals;
a clock signal generator configured to generate a clock signal in response to the reference voltage; and
a pump unit configured to generate a high voltage in response to the clock signal.

13. The semiconductor device of claim 12, wherein the detection circuit comprises:
a number of resistors within each of the voltage lines, wherein the number of resistors are coupled in series within the voltage detection unit; and
a number of enable switches coupled to the respective voltage detection units.

14. The semiconductor device of claim 13, wherein each of the voltage detection units has one side in common coupled to a power supply voltage input terminal and another side coupled to the voltage comparison circuit.

15. The semiconductor device of claim 14, wherein:
the resistors in each of the voltage detection units are coupled to the power supply voltage input terminal, and
the respective enable switch of the voltage detection unit is coupled at a node between the resistors and the voltage comparison circuit.

16. The semiconductor device of claim 13, wherein each of the enable switches comprises an NMOS transistor.

17. The semiconductor device of claim 13, wherein each of the enable switches is coupled between a ground voltage input terminal and a respective output node of the respective voltage detection units.

18. The semiconductor device of claim 12, wherein the voltage comparison circuit comprises a number of comparators coupled to respective output nodes of the voltage detection units and configured to output the respective control signals.

19. The semiconductor device of claim 18, wherein each of the comparators is configured to output the control signal of a logic high level in response to a level of the voltage outputted from the detection circuit being higher than the constant voltage and to output the control signal of a logic low level in response to a level of the voltage outputted from the detection circuit being lower than the constant voltage.

20. The semiconductor device of claim 12, wherein the constant voltage comprises a bandgap voltage.

21. The semiconductor device of claim 12, wherein the reference voltage generator comprises:
a resistor line including a number of resistors coupled in series between a power supply voltage input terminal and a ground voltage input terminal;
a reference output line coupled to a node between the resistor connected to the ground voltage input terminal and other resistors,; and
a number of switches each coupled between the reference output line and a respective node between the resistors.

22. The semiconductor device of claim 21, wherein the switches are operated in response to the respective control signals and configured to output the reference voltage to the reference output line.

23. The semiconductor device of claim 12, wherein the clock signal generator comprises:
a clock voltage generator configured to generate inverted signals in response to a first input signal and an inverted first input signal;
a clock voltage correction unit configured to compare the reference voltage and each of the inverted signals; and
a clock output unit configured to output the clock signal in response to signals generated from the clock voltage correction unit.

24. The semiconductor device of claim 23, wherein the clock voltage generator comprises:
a first inverter configured to invert the inverted first input signal and to output an inverted signal of the first inverter; and
a second inverter configured to invert the first input signal and to output an inverted signal of the second inverter.

25. The semiconductor device of claim 24, wherein the clock voltage correction unit comprises:
a first comparator configured to compare a level of the reference voltage and a level of the inverted signal outputted from the first inverter, and to output a signal of a logic high or low level in response to the comparison of the level of the reference voltage and the level of the inverted signal outputted from the first inverter; and
a second comparator configured to compare a level of the reference voltage and a level of the inverted signal outputted from the second inverter, and to output a signal of a logic low or high level in response to the comparison of the level of the reference voltage and the level of the inverted signal outputted from the second inverter.

26. The semiconductor device of claim 25, wherein:
the clock output unit comprises a first NAND gate configured to generate a second input signal and a second NAND gate configured to generate an inverted second input signal,
the first NAND gate is configured to output the second input signal in response to the inverted second input signal and the signal outputted from the first comparator, and
the second NAND gate is configured to output the inverted second input signal in response to the second input signal and the signal outputted from the second comparator.
